(19) United States
(12) Patent Application Publication
(10) Pub. No.: US 2023/0237477 A1
(43) Pub. Date: Jul. 27, 2023

(54) METHODS AND DEVICES FOR VALIDATING DATA IN A BLOCKCHAIN NETWORK

(71) Applicant: NChain Licensing AG, Zug (CH)

(72) Inventors: Steven Patrick COUGHLAN, London (GB); Wei ZHANG, London (GB)

(21) Appl. No.: 18/011,475

(22) PCT Filed: Jun. 15, 2021
(86) PCT No.: PCT/EP2021/066040

§ 371 Date: Dec. 19, 2022

(30) Foreign Application Priority Data
Jun. 26, 2020 (GB) 2009798.6

(51) Int. Cl. G06Q 20/38; G06Q 20/40

(52) U.S. Cl. CPC G06Q 20/389; G06Q 20/401

(57) ABSTRACT

Methods, devices, and a data structure for signalling Merkle proof data that includes an index position field for the position of the transaction within the ordered set of transactions within the block. The index enables computationally straight-forward determination of the left-hand/right-hand location of each calculated element when bottom-up tracing a Merkle path. Methods and devices for performing a Merkle proof using the index include at least one extended validity check within the Merkle proof process. In some instances, the extended validity check enables validation of transaction count for a block and/or a proof of index validity.

### CROSS REFERENCE TO RELATED APPLICATIONS

This application is the U.S. National Stage of International Application No. PCT/EP2021/066040 filed on Jun. 15, 2021, which claims the benefit of United Kingdom Patent Application No. 2009798.6, filed on Jun. 26, 2020, the contents of which are incorporated herein by reference in their entireties.

### TECHNICAL FIELD

The present disclosure relates to blockchain networks and, in particular, to methods and devices for validating data in a blockchain network, such as validating the presence and index of a transaction within a block.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain is formed from a chain of blocks of data, wherein each block includes one or more transactions. Each transaction, other than so-called “coinbase transactions”, points back to a preceding transaction in a sequence which may span one or more blocks up until one or more coinbase transactions. Coinbase transactions are discussed below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at a node, and the publication of blocks can be achieved through the publication of mere block headers.

The transactions in the blockchain are used to perform one or more of the following: to convey a digital asset (i.e. a number of digital tokens), to order a set of journal entries in a virtualised ledger or registry, to receive and process timestamp entries, and/or to time-order index pointers. A blockchain can also be exploited in order to layer additional functionality on top of the blockchain. Blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in detail below. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction includes one or more inputs and one or more outputs. Any spendable output includes an element specifying an amount of the digital asset that is derivable from the proceeding sequence of transactions. The spendable output is sometimes referred to as a UTXO (“unspent transaction output”). The output may further include a locking script specifying a condition for the future redemption of the output. A locking script is a predicate defining the conditions necessary to validate and transfer digital tokens or assets. Each input of a transaction (other than a coinbase transaction) includes a pointer (i.e. a reference) to such an output in a preceding transaction, and may further include an unlocking script for unlocking the locking script of the pointed-to output. Consider that a pair of transactions may be labelled a first and a second transaction (or “target” transaction). The first transaction includes at least one output specifying an amount of the digital asset, and having a locking script defining one or more conditions of unlocking the output. The second, target transaction has at least one input, including a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

In order for the blockchain network to be practically useful to large numbers of participants, an end user device may operate a client application (sometime referred to as a “wallet” or Simplified Payment Verification (SPV) software). Such a client application lacks the functionality of a full blockchain node and does not have a full copy of the blockchain. The end user device, through its client application, may send a request to a blockchain node for data proving that a particular transaction is present in a blockchain, i.e. that it has been included in a block, meaning it has been “confirmed”. It would be advantageous to have improved methods and devices for providing such data and enabling end user devices or other nodes to prove inclusion of a transaction in a block and/or to prove other features of a block.

### BRIEF DESCRIPTION OF THE DRAWINGS

Reference will now be made, by way of example, to the accompanying drawings which show example embodiments of the present application and in which:

FIG. 1 shows an example system for implementing a blockchain;

FIG. 2 illustrates an example transaction protocol;

FIG. 3A shows an example implementation of a client application;

FIG. 3B shows an example of a user interface for the client application;

FIG. 4 illustrates example node software for a blockchain node;

FIG. 5A shows an example of a Merkle tree;

FIG. 5B shows an example of a “partial” Merkle tree;

FIG. 6 shows an example of a Merkle path; and

FIG. 7 shows, in flowchart form, one example method of validating blockchain data.

Like reference numerals are used in the drawings to denote like elements and features.

### DETAILED DESCRIPTION OF EXAMPLES

In one aspect, there may be provided a computer-implemented method to determine validity of data in a blockchain. The method may include receiving, from a remote node, an index of a transaction within a block and an ordered set of hashes for a Merkle proof; starting from a bottom level of a Merkle tree, for each level of the Merkle tree until reaching a top level, selecting, in order, a provided hash from the ordered set of hashes, concatenating the provided hash and a calculated hash for the current level in an order determined based on the index, hashing the concatenation to find the calculated hash of a level above; determining from the index and each pair of the calculated hash and its corresponding provided hash from the ordered set of hashes whether the transaction is the last transaction in the block; comparing the calculated hash for the top level with a Merkle root in a header for the block; and outputting a result of the comparing and determining.

In some implementations, the index received may be a positional index indicating the position of the transaction in an ordered set of transactions within the block. In some examples, the method may further include, for each level above a bottom level, determining the index for that level based on the index of a level below modulo 2.

In some implementations, determining that the transaction is the last transaction in the block may include determining that each calculated hash, other than the calculated hash for the top level, is a right-hand element within the Merkle tree.

In some implementations, determining that the transaction is the last transaction in the block may include determining that, for any calculated hash that is a left-hand element in its pairing, its corresponding provided hash is equal to the calculated hash.

In some implementations, determining whether the transaction is the last transaction in the block may include determining that the transaction is not the last transaction in the block based on determining that at least one calculated hash is a left-hand element and its corresponding provided hash is not equal to that at least one calculated hash.

In some implementations, the method may further include determining that the index is invalid based on determining that at least one calculated hash is a right-hand element and its corresponding provide hash is equal to that at least one calculated hash.

In some implementations, the method may further include first sending, to the remote node, a request for Merkle proof data with an identifier for the transaction. In some examples, receiving includes receiving a message including a version field, an index field containing the index, and a path field containing a data structure that includes the ordered set of hashes.

In some implementations, the calculated hash for the bottom level of the Merkle tree may be the transaction identifier for the transaction.

In some implementations, an order determined based on the index may include determining whether the calculated hash is a left-hand element or a right-hand element within its pairing with its corresponding provided hash, and wherein determining whether the calculated hash is a left-hand element or a right-hand element is based on determining if the index for that level is even or odd based on index modulus 2.

In some implementations, the ordered set of hashes includes a syntax element to signal a duplicated hash instead of including a duplicated hash value.

In another aspect, there may be provided a computing device implementing a node on a blockchain. The computing device may include memory, one or more processors, and computer-executable instructions that, when executed, cause the processors to carry out one or more of the methods described herein.

In yet another aspect, there may be provided a computer-readable medium storing processor-executable instructions, the processor-executable instructions including instructions that, when executed by one or more processors, cause the processors to carry out at least one of the methods described herein.

Other example embodiments of the present disclosure will be apparent to those of ordinary skill in the art from a review of the following detailed description in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

### Example System Overview

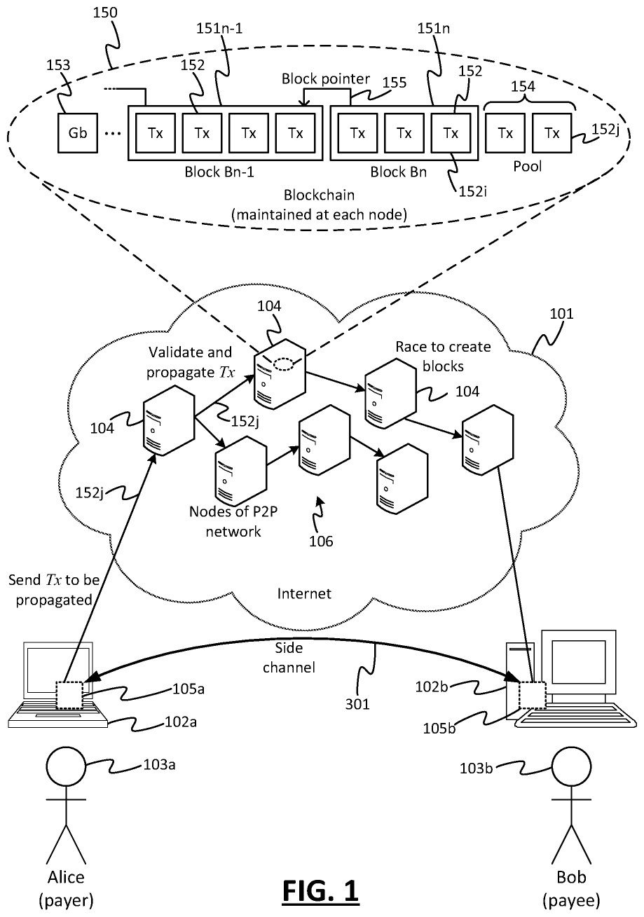

FIG. 1 shows an example system 100 for implementing a blockchain 150. The system 100 may include a packet-switched network 101, typically a wide-area internetwork such as the Internet. The packet-switched network 101 includes a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 includes computer equipment of a peer, with different ones of the nodes 104 belonging to different peers. Each blockchain node 104 includes a processing apparatus implemented by one or more processors, e.g. one or more central processing units (CPUs), accelerator processors, application specific processors and/or field programmable gate arrays (FPGAs), and other equipment such as Application Specific Integrated Circuits (ASICs). Each node also includes memory, i.e. computer-readable storage in the form of a non-transitory computer-readable medium or media. The memory may include one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 includes a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain includes one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 has at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also includes a block pointer 155 pointing back to the previously created block 151 in the chain so as to define a sequential order to the blocks 151. Each transaction 152 (other than a coinbase transaction) has a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input includes a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also includes the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may include checking that the cryptographic signature or other authorisation of the entity 103 included in the input of the new transaction 152j matches a condition defined in the output of the preceding transaction 152i which the new transaction assigns, wherein this condition typically includes at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this includes searching for a “nonce” value such that when the nonce is concatenated with a representation of the ordered set of transactions 154 and hashed, then the output of the hash meets a predetermined condition. For example, the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly-defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server that includes one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus including one or more processors, e.g. one or more CPUs, GPUs, other accelerator processors, application specific processors, and/or FPGAs. The computer equipment 102 of each party 103 further includes memory, i.e. computer-readable storage in the form of a non-transitory computer-readable medium or media. This memory may include one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software such as a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 includes at least one user terminal, e.g. a desktop or laptop computer, a tablet, a smartphone, or a wearable device such as a smartwatch. The computer equipment 102 of a given party 103 may also include one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 includes at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality includes collating the amounts defined in the outputs of the various 152 transactions scattered throughout the blockchain 150 that belong to the party in question.

It will be understood that whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This may include first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151, and eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 includes a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

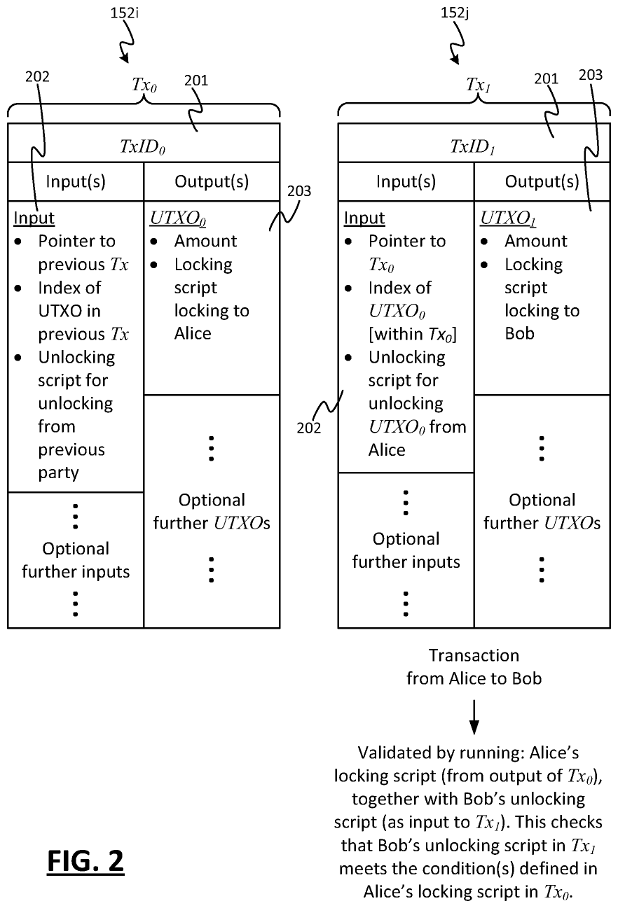

FIG. 2 illustrates an example transaction protocol. This is an example of a UTXO-based protocol. A transaction 152 (abbreviated “Tx”) is the fundamental data structure of the blockchain 150 (each block 151 containing one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 is a data structure having one or more inputs 202, and one or more outputs 203. Each output 203 may include an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also include a header 201, which may include an indicator of the size of the input field(s) 202 and output field(s) 203. The header 201 may also include an ID of the transaction. In some embodiments, the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ is a particular UTXO, labelled here UTXO₀. Each UTXO includes a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). That is, the locking script defines an unlocking condition, typically include a condition that the unlocking script in the input of the subsequent transaction include the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ includes a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ includes a pointer pointing back to Tx₁ (e.g. by means of its transaction ID, TxID₀, which in some embodiments is the hash of the whole transaction Tx₀). The input 202 of Tx₁ includes an index identifying UTXO₀ within Tx₀, to identify it amongst any other possible outputs of Tx₀. The input 202 of Tx₁ further includes an unlocking script <Sig P_{A}>which has a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This may include running the locking script and unlocking script together to check whether the unlocking script meets the condition defined in the locking script (where this condition may include one or more criteria). In some embodiments this may involve concatenating the two scripts:

<Sig P_{A}><P_{A}>∥[Checksig P_{A}]

where “H” represents a concatenation and “< . . . >” means place the data on the stack, and “[ . . . ]” is a function carried out by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data includes the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically includes hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice, a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However, the amount from the UTXO can be split between multiple outputs of the next transaction. For example, the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. For example, say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence, typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. For example, the data could include a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically includes the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed includes authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may include additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may include any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

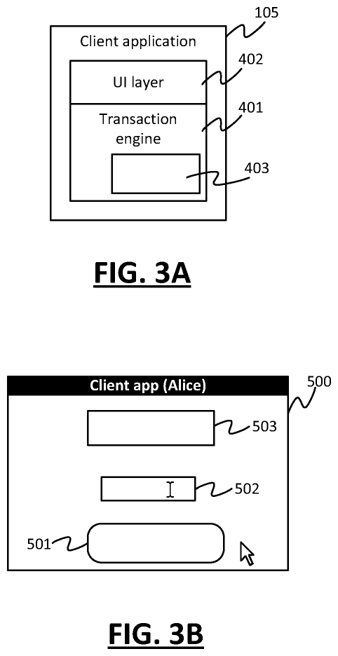

FIG. 3A illustrates an example implementation of the client application 105 for implementing embodiments of the presently disclosed scheme. The client application 105 may include a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the processes discussed above.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could include one or more display screens (touch or non-touch screen) for providing a visual output, one or more speakers for providing an audio output, and/or one or more haptic output devices for providing a tactile output, etc. The user input means could include for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note that whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may include one or more UI elements 501, 502, 502 rendered as distinct UI elements via the user output means.

For example, the UI elements may include one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may include one or more data entry fields 502. These data entry fields 502 are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may include one or more information elements 503 output to output information to the user. For example, the information could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3B is only a schematized mock-up and in practice it may include one or more further UI elements, which for conciseness are not illustrated.

### Node Software

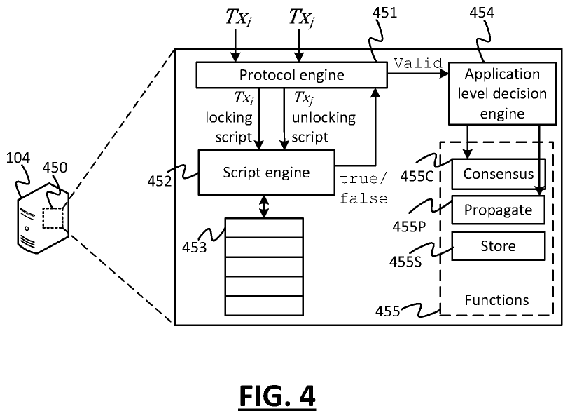

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This may include the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. For example, the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In some embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In some other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Merkle Proofs

As described above, mining nodes group transactions into a block. The payload of the block contains an ordered set of the transactions, including the coinbase transaction. Each block has a block header that includes various data fields, including a Merkle root. The Merkle root may be considered a summary or “fingerprint” of the data in the payload, i.e. of the ordered set of transactions. The Merkle root is determined through building a Merkle tree.

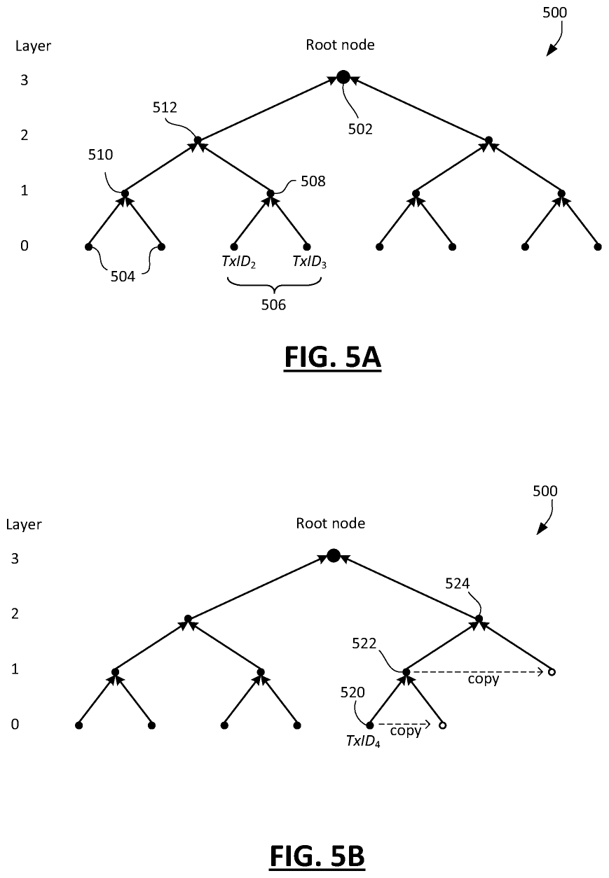

A Merkle tree for an ordered set of elements is built through hashing each element and recursively creating a next layer by concatenating adjacent pairs of hashed elements and hashing the concatenated hashed elements. A simplified example of a Merkle tree 500 is shown in FIG. 5A.

In this example, the Merkle tree 500 relates to an ordered set of only eight elements, for ease of illustration. The Merkle trees in other examples may be smaller or, more commonly, much larger. Layers of the Merkle tree 500 are labelled from the bottom up, with layer 0 being the base layer, and layer 3, in this example, being a Merkle root 502. The Merkle tree 500 is formed by first creating the base layer through hashing of the elements. That is, each base layer node 504 is a hash of the corresponding element in that position. In the case of bitcoin, each base layer node 504 is a hash (double-SHA256, in the case of bitcoin) of its corresponding transaction. The double-SHA256 hash of a transaction is also its transaction identifier, TXID. Accordingly, in the case of bitcoin, each of the base layer nodes 504 is a TXID corresponding to the transaction in that position in the ordered set of transactions in a block.

To build the layer 1 nodes of the Merkle tree 500, the base layer nodes are grouped into pairs. Within each pair, the elements are concatenated and then hashed to find the value of the parent node at the layer above. For example, if a base layer pair 506 includes TxID₂ and TxID₃, then the two TxID are concatenated as TxID₂∥TxID₃, and the resulting value is hashed to calculate element 508.

Layer 2 elements are calculated as hashes of concatenated pairs of layer 1 elements, and so on. For example, element 512 is calculated from a hash of the concatenated pair of element 510 and element 508. The building of the layer through calculating intermediate hashes for the nodes at intermediate layers of the Merkle tree 500 continues until it results in a single element at a top layer, referred to as the Merkle root 502.

It will be appreciated that not every block with have a full set of transactions that includes exactly 2″ elements. Such cases may result in a “partial” Merkle tree. FIG. 5B illustrates an example in which there are five elements at layer 0, e.g. five transactions in a block. While the first four elements can be paired, the last transaction indicated by reference numeral 520 has no corresponding paired element. It will be appreciated that the missing paired element at the base layer only arises in the case where the last element is a left-hand member of the pair. For the purposes of building the Merkle tree in this situation, a “copy” of the left-hand element is used as the right-hand element; that is, the TxID₄ indicated by numeral 520 is concatenated with itself and is hashed to find the value of its parent element at node 522. Likewise, because node 522 has no corresponding right-hand element in its pairing, the element at node 522 is concatenated with itself and hashed to find the value of its parent element at node 524 in layer 2.

The Merkle root 502 is inserted into the header of a block to serve as a fingerprint of the transactions within the block.

Merkle trees are useful to enable lightweight nodes, such as client applications on end user devices, to determine whether a certain transaction is present in a block on the blockchain without necessarily having to download the entire block or the full blockchain. A client application may determine whether a transaction is present in a block based on a Merkle proof. A Merkle proof involves tracing a path from the transaction to the Merkle root through the Merkle tree to confirm that the transaction was included in the block.

A node may request data relating to a transaction from which it can perform a Merkle proof. In one example, the requested data may be provided in the form of an ordered set of hashes corresponding to the paired hashes within the Merkle tree required along the path in order to arrive at the Merkle root, along with binary signals indicating whether the calculated and/or provided hash is a left-hand or right-hand element of each pairing.

For the purpose of the discussion herein, the following conventions may be used. An element that is calculated using hashing of available data (e.g. transaction data or concatenated elements of a Merkle tree) may be indicated using c[n], where n refers to the layer of the tree and the bottom or base layer is at n=0. An element of the tree, e.g. an intermediate hash, provided by another node for the purposes of the Merkle proof may be indicated using p[n].

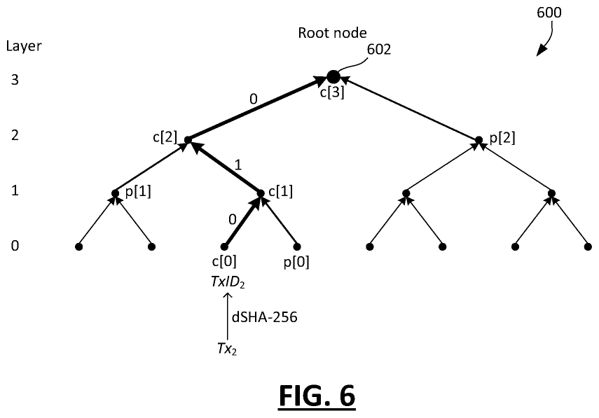

FIG. 6 shows an example of a Merkle path through a Merkle tree 600. The Merkle path in this case relates to validating the presence of transaction Tx in a block. To complete the Merkle proof using this Merkle path, a computing device has the transaction Tx (or at least the TxID) and an ordered set of hashes (intermediate hashes) corresponding to the needed elements to form pairs along the Merkle path. In this example, the ordered set includes p[0], p[1], p[2].

The computing device also needs a mechanism for determining whether the provided intermediate hashes are left-hand or right-hand elements of a pairing. This can be signalled using binary flags in some cases. The binary flag may indicate, for each layer, whether the calculated hash (or provided hash) is the left-hand or right-hand element. In some cases, instead of signalling whether the calculated hash (or provided hash) at each layer is the left-hand or right-hand element, the position of the calculated hash in the bottom or base layer may be signalled, i.e. its index in the ordered set of elements. In some implementations, these may be effectively equivalent. For example, bitwise signalling of the left-hand (0) or right-hand (1) path tracing the calculated elements of layers 2 to 0 moving down the Merkle path from a Merkle root 602, results in the bits [0, 1, 0]. Equivalently, the index i=2 of the c[0] element may be signalled, which in binary is 010. Other implementations may use different signalling or coding.

To carry out the Merkle proof, the computing device determines the c[0] element by hashing (in this example, double-SHA256) the transaction Tx to obtain the TxID. In some cases, it may already have the TxID. It then concatenates it with the first provided hash in the ordered set of hashes, p[0]. The computing device determines from the index i or from the bit signalling whether the calculated hash c[0] is a left-hand or right-hand element and concatenates accordingly. It then hashes the concatenation to determine c[1]. It carries on with this process until it determines c[3], which it then compares to the Merkle root 602 found in the block header. If it matches, then the computing device has determined that the transaction Tx is included in the block. If not, then the transaction Tx is not in the block (or the Merkle path hashes it was provided contain an error).

The position of an element in the ordered set of elements in a layer may be referred to as an “index” and represented by i or by indexOf(c[n]) when referring to the index of a calculated element within the nth layer. At the bottom or base layer, the index i ranges from 0 to the count of transactions in the block less one.

In one aspect, the present application discloses a data structure for signalling Merkle proof data that advantageously includes an index position field, which makes determination of the left-hand/right-hand location of each calculated element easier than top-down tracing of a path based on a bitvector. In another aspect, the present application provides for at least one extended validity check within the Merkle proof process. In some instances, the extended validity check enables validation of transaction count for a block and/or a proof of index validity.

The use of positional index as the mechanism for determining left-hand or right-hand position of calculated elements along the Merkle path, enables use of a simple modulus calculation to determine left/right handedness. A “mod 2” operation effectively produces a result that signals whether the value is even or odd. For example, the expression “indexOf(c[n]) mod 2” produces a 0 for even values of indexOf(c[n]) and produces a 1 for odd values of indexOf(c[n]). The value of indexOf(c[n]) can then be divided by two to determine an index value for the calculated element of the layer above, i.e. indexOf(c[n+1]). Implementations may use a floor function when dividing by two to drop any remainder if the division operation is done in floating point math.

One extended validity check that may be enabled by use of the positional index is to confirm that, if the index indicates that any of the calculated elements are right-hand elements, e.g. if indexOf(c[n]) mod 2==1, then the corresponding left-hand element p[n] cannot be equal to c[n], or the positional index is likely erroneous. Despite the positional index being erroneous it is possible that such a situation could result in a valid Merkle root calculation. For example, if the proper positional index points to a left-hand element at the end of the transaction list, but the positional index erroneously points to the right-hand copied element, the Merkle root calculation may be correct, despite the index value being wrong.

A further extended validity check that may be enabled by the use of the positional index is ability to identify the last transaction in a block. The computing device may or may not know the total number of transactions in a block; the transaction count is a field in a block, but not necessarily in the block header, so the computing device may not have such information. Whether it has that information or not, the computing device may be able to validate that the transaction is actually the last transaction in the block through finding that either the calculated values are all right-hand elements at every layer of the Merkle tree, or that if the calculated value c[n] is a left-hand element at any layer then the corresponding provided hash p[n] is equal to c[n]. From validating that the transaction is the last in the ordered set, i.e. the last transaction in the block, the computing device thereby determines (or validates if it already has that information) the count of transactions in the block.

It will be understood that in some data structure implementations, rather than providing a p[n] that is a copy of c[n] within the ordered set of hashes, the providing node may signal that c[n] should be copied for that layer. A particular code, signal, flag, or other syntax element may be used to signal that a copy of c[n] should be used instead of a provided hash.

The following is one example data structure for sending Merkle proof data:

version: byte, //0x00 default

index: varint, //bitcoin style varint

path: hash[], //array of 32 byte hashes

header: byte [80]//included dependent on version

duplicated_indexes_count: varint,

duplicated_indexes: varint []

In the above example, the positional index of c[0] within the bottom layer of the Merkle tree is provided in the index field. The version field may be used to signal various options. For example, the original transaction may or may not be signalled, the Merkle root may or may not be included, the block header may or may not be included, etc. The version field signals which combination of features are included. Example versions may include, but are not limited to:

0x00—tx_id is omitted, final element is block_hash
0x01—tx_id is included, final element is block_hash
0x02—tx_id is omitted, final element is block_header
0x03—tx_id is included, final element is block_header
0x04—tx_id is omitted, final element is merkle_root
0x05—tx_id is included, final element is merkle_root
0x06—tx_id is omitted, final element is omitted
0x07—tx_id is included, final element is omitted

The path field contains the ordered set of provided hashes. In some instances, the path data structure is a complete set of provided hashes and in some instances it contains sufficient information that can be expanded or decoded to produces the complete set of provided hashes. Inclusion of the original TxID (e.g. c[0]) and the Merkle root are determined based on the version code.

In some instances, where p[n] is a copy of c[n], p[n] may not be included in the path data structure and may be replaced with a syntax element to signal that p[n] is a copy. As an example, in JSON the special string “*” may be used to signal copy.

The duplicated_indexes and duplicated_indexes_count fields may be included or not. If included then the count of copied p[n] elements and the layers n in which they occur may be signalled using these fields. If this mechanism for signalling copied p[n] elements is used then it will be appreciated that the path field will not contain either a hash or a syntax element signalling copy with respect to those layers.

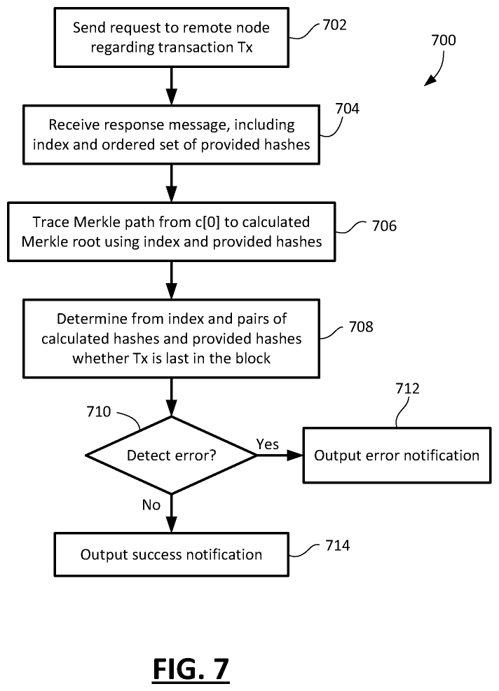

FIG. 7 shows, in flowchart form, one simplified example method 700 for determining whether a transaction is included in a block. The method 700 may be implemented by a network-connected computing device, which may be a blockchain node or an end user device, for example using a client application. The method 700 may be implemented by way of processor-executable instructions that, when executed by a processor, cause the processor to carry out the described operations. The operations may involve memory access functions, signal or data reception or transmission functions, display operations, and other operations involving components coupled to the processor. The instructions may be embodied in one or more software modules, applications, routines, etc.

The method 700 may, in some cases, be initiated by the computing device issuing a request to a remote node, as indicated by operation 702. The remote node may be a blockchain node or may be an end user device. For example, the computing device may be a first end user device and the remote note may be a second end user device, both of which are engaged in negotiating or finalizing a transaction. The request relates to confirmation that a specific transaction Tx is included in a block on the blockchain. The request may be sent to more than one remote node in some examples. The request may include a copy of the Tx or a unique identifier for the Tx, such as its TxID.

In response to the request, in operation 704 the computing device may receive a reply message that contains, at least, a positional index associated with the Tx in a particular block, and path data. The path data may include an ordered set of hashes. The ordered set of hashes may include provided hashes for conducting a Merkle proof relating to the Tx within the Merkle tree for the particular block.

In operation 706, the computing device carries out the Merkle proof starting from the bottom level of the Merkle tree and recursively calculating the calculated element, identifying the corresponding provided element in the ordered set of hashes, concatenating them in accordance with the index, and hashing to find the parent calculated element. The computing device builds the Merkle path until it reaches the Merkle root. The computing device may know it has reached the Merkle root based on knowing the number of levels in the Merkle tree, or it may be able to infer the number of levels in the Merkle tree from the fact there are no further hashes in the ordered set of hashes.

In operation 708, the computing device determines, from the index and the pairs of calculated hashes and corresponding provided hashes, whether the transaction is the last transaction in the block. The computing device may identify the transaction as the last transaction in the block based on the index if at every level, except the Merkle root, the index indicates that the calculated element is the right-hand element. Such as situation only occurs when the Merkle tree is “full”, i.e. there are exactly 2″ elements in the base layer, and the transaction is the right-most element. The computing device may further identifier if the transaction is the last transaction in the block in the case of a ‘partial’ (e.g. non-full) Merkle tree if whenever the calculated element is a left-hand member of the pair that the corresponding provided right-hand member, p[n], is a copy. That is, c[n]=p[n] for every n in which indexOf(c[n])=0.

It will be appreciated that operation 708, although shown separately for ease of discussion, may be performed concurrently with operation 706 as the Merkle path is built.

In operation 710, the computing device may determine if an error has been detected. One error may be determination that the calculated Merkle root does not match the Merkle root in the block header. Another error may be detection of a case in which the calculated element is a right-hand element and the provided hash in the left-hand position of that pair is a copy of the calculated element. In either case, in operation 712, the computing device outputs an error notification. The error notification may indicate the nature of the detected error, i.e. mis-matched Merkle root or left-hand copy error. Otherwise, the computing device outputs a success notification in operation 714, confirming that the Merkle proof is valid and the transaction Tx is contained in the block at the specified position index. The success notification may further indicate whether the Tx has been determined to be the last Tx in the block and, if so, the total number of transactions in that block.

The notifications in operations 712 and 714 may include an output on the computing device, such an auditory notification, a visual notification, and/or a haptic notification. The notification may include display of a user interface message detailing the results of the Merkle proof analysis and determinations. In some cases, the notifications may include transmission of a results message to one or more remote nodes, which may include the remote node from which the path data was obtained in operation 704.

One example implementation is illustrated by way of the following example code. The example code is provided in javascript form and presumes that the provided set of hashes is a data structure of length “hashes.length”, which further indicates the number of layers in the Merkle tree, and that the Merkle root is provided as the final element in the hashes data structure. In this example, the computing device has a copy of the transaction, indicated by “tx”. The hashing algorithm used in this example is bitcoin' s standard double-SHA256 hash, which is indicated by the function “sha256d()”.

```
let layers = hashes.length; //number of layers in tree
let merkle_root = hashes[hashes.length − 1];
let txid = sha256d(tx);
let n = 0; //current layer
let i = index; //index of node in current layer
let c = txid;
let is_last_in_tree = true;
foreach (hash in hashes) {
  //don't process the last element as it's the merkle root
  if (n == hashes.length − 1)
    break;
  let c_is_left = i % 2 == 0;
  let p = hashes[n];
  //Check for duplicate hash
  if (p == ″*″) {
    p = c;
  }
  //Test for invalid index
  if (p == c && !c_is_left) {
    //this should happen so we can fail here
    throw ′left node cannot be a copy′;
  }
  //Determine if not-last element
  if (c_is_left && c != p) {
    is_last_in_tree = false;
  }
  //Calculate the parent node
  let parentC = c_is_left? sha256d(c, p) : sha256d(p, c);
  c = parentC;
  //Update index for next layer
  n++;
  //We need integer division here with remainder dropped.
  //Javascript does floating point math by default so we
  //need to use Math.floor to drop the fraction.
  i = Math.floor(i / 2);
}
//c is now the calculated merkle root
let is_proof_valid = c == merkle_root
```

It will be appreciated that the above code is just one example implementation. Other coding languages, structures, and techniques may be used in other implementations.

The provided data from the remote node may include the Merkle root, the block header containing the Merkle root, and/or a block hash. In some cases the computing device, such as an end user device running a client application, has or has access to a pre-verified block headers and an index of block hash to headers; in which case, the remote node may provide the block hash to enable the computing device to locate the corresponding pre-verified block header and extract its Merkle root for validating the proof. Advantageously, the pre-verified block headers and corresponding block hash information may have been obtained from one or a number of other remote blockchain nodes so that the computing device is confident that the block headers represent the current longest proof-of-work chain and that they have been verified by a number of blockchain nodes.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method to determine validity of data in a blockchain, comprising:
receiving, from a remote node, an index of a transaction within a block and an ordered set of hashes for a Merkle proof;
starting from a bottom level of a Merkle tree, for each level of the Merkle tree until reaching a top level,
selecting, in order, a provided hash from the ordered set of hashes,
concatenating the provided hash and a calculated hash for the current level in an order determined based on the index,
hashing the concatenation to find the calculated hash of a level above;
determining from the index and each pair of the calculated hash and its corresponding provided hash from the ordered set of hashes whether the transaction is the last transaction in the block;
comparing the calculated hash for the top level with a Merkle root in a header for the block; and
outputting a result of the comparing and determining.

2. The method of claim 1, wherein the index received is a positional index indicating the position of the transaction in an ordered set of transactions within the block.

3. The method of claim 2, further comprising, for each level above a bottom level, determining the index for that level based on the index of a level below modulo 2.

4. The method of claim 1, wherein determining that the transaction is the last transaction in the block includes determining that each calculated hash, other than the calculated hash for the top level, is a right-hand element within the Merkle tree.

5. The method of claim 1, wherein determining that the transaction is the last transaction in the block includes determining that, for any calculated hash that is a left-hand element in its pairing, its corresponding provided hash is equal to the calculated hash.

6. The method of claim 1, wherein determining whether the transaction is the last transaction in the block includes determining that the transaction is not the last transaction in the block based on determining that at least one calculated hash is a left-hand element and its corresponding provided hash is not equal to that at least one calculated hash.

7. The method of claim 1, further comprising determining that the index is invalid based on determining that at least one calculated hash is a right-hand element and its corresponding provide hash is equal to that at least one calculated hash.

8. The method of claim 1, further comprising first sending, to the remote node, a request for Merkle proof data with an identifier for the transaction.

9. The method of claim 8, wherein receiving includes receiving a message including a version field, an index field containing the index, and a path field containing a data structure that includes the ordered set of hashes.

10. The method of claim 1, wherein the calculated hash for the bottom level of the Merkle tree is the transaction identifier for the transaction.

11. The method of claim 1, wherein an order determined based on the index includes determining whether the calculated hash is a left-hand element or a right-hand element within its pairing with its corresponding provided hash, and wherein determining whether the calculated hash is a left-hand element or a right-hand element is based on determining if the index for that level is even or odd based on index modulus 2.

12. The method of claim 1, wherein the ordered set of hashes includes a syntax element to signal a duplicated hash instead of including a duplicated hash value.

13. A computing device, the computing device including:
one or more processors;
memory;
computer-executable instructions stored in the memory that, when executed by the one or more processors, cause the processors to:
receive, from a remote node, an index of a transaction within a block and an ordered set of hashes for a Merkle proof;
starting from a bottom level of a Merkle tree, for each level of the Merkle tree until reaching a top level,
select, in order, a provided hash from the ordered set of hashes,
concatenate the provided hash and a calculated hash for the current level in an order determined based on the index, and
hash the concatenation to find the calculated hash of a level above;
determine from the index and each pair of the calculated hash and its corresponding provided hash from the ordered set of hashes whether the transaction is the last transaction in the block;
compare the calculated hash for the top level with a Merkle root in a header for the block; and
output a result of the comparing and determining.

14. A non-transitory computer-readable storage medium storing processor-executable instructions, the processor-executable instructions including instructions that, when executed by one or more processors, cause the one or more processors to:
receive, from a remote node, an index of a transaction within a block and an ordered set of hashes for a Merkle proof;
starting from a bottom level of a Merkle tree, for each level of the Merkle tree until reaching a top level,
select, in order, a provided hash from the ordered set of hashes,
concatenate the provided hash and a calculated hash for the current level in an order determined based on the index, and
hash the concatenation to find the calculated hash of a level above;
determine from the index and each pair of the calculated hash and its corresponding provided hash from the ordered set of hashes whether the transaction is the last transaction in the block;
compare the calculated hash for the top level with a Merkle root in a header for the block; and
output a result of the comparing and determining.

15. The computing device of claim 13, wherein the index received is a positional index indicating the position of the transaction in an ordered set of transactions within the block.

16. The computing device of claim 15, wherein the instructions, when executed, are to further cause the processor to, for each level above a bottom level, determine the index for that level based on the index of a level below modulo 2.

17. The computing device of claim 13, wherein the instructions, when executed, are to cause the processor to determine that the transaction is the last transaction in the block by determining that each calculated hash, other than the calculated hash for the top level, is a right-hand element within the Merkle tree.

18. The computing device of claim 13, wherein the instructions, when executed, are to cause the processor to determine that the transaction is the last transaction in the block by determining that, for any calculated hash that is a left-hand element in its pairing, its corresponding provided hash is equal to the calculated hash.

19. The computing device of claim 13, wherein the instructions, when executed, are to cause the processor to determine whether the transaction is the last transaction in the block by determining that the transaction is not the last transaction in the block based on determining that at least one calculated hash is a left-hand element and its corresponding provided hash is not equal to that at least one calculated hash.

20. The computing device of claim 13, wherein the instructions, when executed, are to further cause the processor to determine that the index is invalid based on determining that at least one calculated hash is a right-hand element and its corresponding provide hash is equal to that at least one calculated hash.
